(19) United States
(12) Patent Application Publication
(10) Pub. No.: US 2012/0292464 A1
(43) Pub. Date: Nov. 22, 2012

(54) CRANE TRANSITION ASSISTING DEVICE, TRANSPORT TRAILER WITH ASSISTING DEVICE AND CRANE DISASSEMBLING/ASSEMBLING METHOD BY USE OF ASSISTING DEVICE

(75) Inventors: Qingyu Huang, Changsha (CN); Munan Liu, Changsha (CN); Xin Zhang, Changsha (CN); Lianxi Deng, Changsha (CN)

(73) Assignees: SANY AUTOMOBILE MANUFACTURE CO., LTD., Changsha, Hunan (CN); HUNAN SANY INTELLIGENT CONTROL EQUIPMENT COL, LTD., Changsha, Hunan (CN)

(21) Appl. No.: 13/380,577

(22) PCT Filed: Jun. 22, 2010
(86) PCT No.: PCT/CN2010/074224

§ 371 Date: Dec. 23, 2011

(30) Foreign Application Priority Data
Nov. 27, 2009 (CN) 200910225695.2

(51) Int. Cl. F16M 11/32; F16M 11/02; B23P 11/00; B60P 1/64

(52) U.S. Cl. 248/125.8; 414/498; 29/428

(57) ABSTRACT

A crane transition assisting device, a transport trailer with the assisting device and a crane disassembling/assembling method by use of the assisting device are disclosed. The crane transition assisting device comprises a bearing frame (130) and supporting legs (110) which are mounted on the bearing frame and are equipped with a hydraulic cylinder (111) telescoping in a vertical direction. The bearing frame (130) is provided with at least two suspension arm brackets (120) arranged along the longitudinal direction of a horizontal plane and used for supporting a suspension arm. The assisting device realizes separation or combination of the suspension arm and a rotary table without an assistant lifting mechanism while disassembling/assembling a large-tonnage wheel crane so as to conveniently realize disassembling/assembling a large-tonnage wheel crane. The transport trailer with the assisting device can provides convenience for carrying a suspension arm, and the crane disassembling/assembling method by use of the assisting device can provides convenience for large-tonnage wheel crane transition.

This application claims the priority of Chinese Patent Application No. 200910225695.2, entitled “CRANE TRANSITION ASSISTING DEVICE, TRANSPORT TRAILER WITH ASSISTING DEVICE AND CRANE DISASSEMBLING/ASSEMBLING METHOD BY USE OF ASSISTING DEVICE” filed on Nov. 27, 2009 with State Intellectual Property Office of PRC, which is incorporated herein by reference in its entirety.

### FIELD OF THE INVENTION

The present invention relates to a crane transition technique, in particular to a crane transition assisting device, a transport trailer with the crane transition assisting device, and a crane reassembling/disassembling method by using this crane transition assisting device.

### BACKGROUND OF THE INVENTION

Compared with a gantry track crane and a crawler crane, a wheel crane has advantages that the transition is easy to perform and the hoisting operation is also flexible, so as to satisfy diversiform demands of construction works. Presently, along with the development of major engineering works, a wheel crane tends to be a large tonnage wheel crane or a super tonnage wheel crane, and the large tonnage wheel cranes (generally referring to the cranes having a tonnage level of 300 ton or above 300 ton) have been widely applied in various engineering construction projects.

On the one hand, with the increasing of the tonnage of large tonnage wheel cranes, overall weights, configurations and outline dimensions of the cranes also tend to increase. On the other hand, for the purpose of protecting road surface and maintaining traffic safety, outline dimensions, axle loads and overall weighs of vehicle are all limited by relevant rules of the road. In this case, a large tonnage wheel crane can not be transferred as a whole.

At present, in order to make the best use of advantages of a wheel crane, transferring and transporting of a large tonnage wheel crane may be achieved in disassembling way. The process of disassembling and transition is as follows, firstly, disassembling a large tonnage wheel crane into several parts; transporting the several parts to a predetermined location by means of a transportation trailer separately; after each of the parts reaching the predetermined location, reassembling respective parts to form the large tonnage wheel crane, so as to perform hoisting operation in the new location. Thus, such an advantage of the wheel crane has been fully embodied.

The large tonnage wheel crane generally includes a chassis, a revolving platform, a boom and a derricking cylinder. The revolving platform is mounted on the chassis by means of a revolving mechanism. The boom has a low end hinged to the revolving platform by a main pin shaft, and the derricking cylinder has two ends hinged to the revolving platform and the boom by a lower pin shaft and an upper pin shaft respectively. The revolving platform, the boom and the derricking cylinder may rotate together relative to the chassis to adjust the position of a hoisting operation, while the derricking cylinder may extend or retract so as to adjust an angle between the boom and the revolving platform to adjust the hoisting amplitude.

In disassembling and assembling of the large tonnage wheel crane, the boom is usually disassembled and assembled as an individual part. Due to the relatively large weight, that the boom is disconnected from or connected with the revolving platform is a key of transition operation of the large tonnage wheel crane. In disassembling the large tonnage wheel crane, a minor assisting hoisting mechanism is generally required to hoist the boom, such that the main pin shaft hinging the boom with the revolving platform is not subjected to a force or is subjected to a smaller force, and then to pull out the main pin shaft. In a substantially same way, the upper pin shaft which hinges the boom with the derricking cylinder is pulled out by the cooperation of the derricking cylinder and the hoisting mechanism, so as to disconnect the boom from the revolving platform of the crane. In reassembling the crane, it is necessary to hoist the boom to a suitable height and position by a hoisting mechanism, and then the main pin shaft and the upper pin shaft are inserted into corresponding hinge points to install the boom on the revolving platform, thus achieving the connection between the boom and the revolving platform.

Since locations where a large tonnage wheel crane is assembled and disassembled are uncertain and diversified, it is sometimes difficult to find an assisting hoisting mechanism, which makes it difficult to disconnect the boom from the revolving platform of a crane and to install the boom on the revolving platform, thus the disassembling and assembling of a large tonnage wheel crane is difficultly implemented, which increases the difficulty in the transferring operation of the large tonnage wheel crane.

### SUMMARY OF THE INVENTION

In view of the technical problems mentioned above, a spirit of the present invention is to provide a technical solution for disassembling/assembling a boom of a crane in terms of a new technique. Based on this spirit, a first object of the present invention is to provide a crane transition assisting device in which the boom may be conveniently disconnected from or connected with the revolving platform of a crane, and thus the disassembling and assembling of a large tonnage wheel crane is conveniently achieved.

Based on the above-mentioned first object, a second object of the present invention is to provide a transport trailer with this crane transition assisting device, in which a large tonnage wheel crane is conveniently disassembled and assembled and a boom is conveniently transferred and transported.

In addition, based on the above-mentioned first object, a third object of the present invention is to provide a method for disassembling and assembling a large tonnage wheel crane.

In order to achieve the first object mentioned above, the crane transition assisting device according to the present invention includes a bearing frame and at least three supporting legs each mounted on the bearing frame. Each of the supporting legs includes a hydraulic cylinder which is telescopic in a vertical direction; and at least two boom brackets arranged in a longitudinal direction of a horizontal plane and configured to support a boom of a crane are provided on the bearing frame.

Preferably, each of the boom brackets is slidably mounted on a transversely sliding rail of the bearing frame, and the transversely sliding rail extends in a transverse direction of the horizontal plane.

Preferably, the crane transition assisting device further includes transversely sliding hydraulic cylinders which are telescopic in a direction perpendicular to the longitudinal direction. Two ends of each transversely sliding hydraulic cylinder are respectively connected with the corresponding boom bracket and the bearing frame.

Preferably, each of the supporting legs further includes a swinging arm extending in a direction parallel to the horizontal plane. An outer end of the swinging arm is connected to an upper end part of the corresponding hydraulic cylinder, and an inner end of the swinging arm is hinged with the bearing frame by a vertical hinge shaft extending in the vertical direction.

Preferably, the outer end of the swinging arm is hinged with the upper end part of the corresponding hydraulic cylinder by a horizontal hinge shaft extending in a direction parallel to the horizontal plane.

Preferably, the upper end part of each hydraulic cylinder further includes a supporting platform extending horizontally. A top surface of the supporting platform abuts against a bottom surface of the corresponding swinging arm when the corresponding hydraulic cylinder is supported on the ground.

Preferably, a protruding block extending in the telescoping direction of the hydraulic cylinder is further provided on the top surface of each supporting platform, and a locating hole is further provided in the bottom surface of each swinging arm. The protruding block is engaged with the corresponding locating hole when the top surface of the supporting platform abuts against the bottom surface of the swinging arm.

Preferably, each of the horizontal hinge shafts is hinged in a first horizontal hinge hole of the upper end part of the corresponding hydraulic cylinder. The first horizontal hinge hole is an elongated hole having a predetermined length in the telescoping direction of the hydraulic cylinder; and the horizontal hinge shaft is adjacent to a lower end of the first horizontal hinge hole when the hydraulic cylinder is supported on the ground.

Alternatively, each of the horizontal hinge shafts is hinged in a second horizontal hinge hole of the outer end of the corresponding swinging arm. The second horizontal hinge hole is an elongated hole having a predetermined length in the vertical direction; and the horizontal hinge shaft is adjacent to an upper end of the second horizontal hinge hole when the hydraulic cylinder is supported on the ground.

Preferably, each of the supporting legs further includes a leg withdrawing hydraulic cylinder. An inner end of the leg withdrawing hydraulic cylinder is hinged with the corresponding swinging arm, and an outer end of the leg withdrawing hydraulic cylinder is hinged with a leg withdrawing hinge hole of the upper end part of the hydraulic cylinder.

Preferably, each of the leg withdrawing hinge holes is an elongated hole having a predetermined length in the telescoping direction of the corresponding hydraulic cylinder.

To achieve the second object described above, the transport trailer according to the present invention includes the crane transition assisting device described above. The bearing frame is supported on a chassis of the transport trailer, and the lower end part of each hydraulic cylinder protrudes downwardly from the outside of the periphery of the chassis of the transport trailer.

To achieve the third object described above, the method for assembling a crane with the above crane transition assisting device according to the present invention includes the steps of:

extending the hydraulic cylinder to move the bearing frame and the boom upwardly; and

placing the revolving platform of the crane under the bearing frame, adjusting the height of the bearing frame, aligning corresponding hinge holes of the boom and the revolving platform, inserting a main pin shaft into the corresponding hinge holes so as to hinge the boom with the revolving platform; and adjusting a derricking cylinder on the revolving platform so as to align corresponding hinge holes of the derricking cylinder and the boom, and then inserting an upper pin shaft into the corresponding hinge holes so as to hinge and connect an upper end of the derricking cylinder with the boom.

A method for disassembling a crane with the above crane transition assisting device according to the present invention includes the steps of:

placing the crane transition assisting device under the boom so as to support the boom on the boom bracket; and

adjusting the position of the derricking cylinder on a revolving platform of the crane, pulling out an upper pin shaft which hinges an upper end of the derricking cylinder with the boom; and adjusting the height of the bearing frame, and pulling out a main pin shaft which hinges the boom with the revolving platform.

The crane transition assisting device according to the present invention includes the bearing frame and the supporting legs for supporting the bearing frame. The supporting leg includes a hydraulic cylinder which can be telescopic along the vertical direction. When it is necessary to detach the boom from the revolving platform, the crane transition assisting device may be supported on the ground, and the boom bracket may be adjusted to have a suitable height by adjusting the length of the hydraulic cylinder; then the boom is placed on the boom bracket of the crane transition assisting device; the hydraulic cylinder and the derrick cylinder on the revolving platform are adjusted to allow the crane transition assisting device to bear the overall weight of the boom, then the upper pin shaft hinging the derricking cylinder with the boom and the main pin shaft hinging the boom with the revolving platform are pulled out respectively, thereby detaching the boom from the revolving platform. When it is necessary to mount the boom on the revolving platform, that is, the boom is connected with the revolving platform, the boom may be placed on the boom brackets of the crane transition assisting device; the length of the hydraulic cylinder is adjusted such that the bearing frame has a suitable height to facilitate the revolving platform going into the location under the bearing frame; then the height of the bearing frame is adjusted such as to align the corresponding hinge holes of the boom and the revolving platform, then the main pin shaft is inserted into the corresponding hinge holes so as to hinge and connect the boom with the revolving platform; the length and position of the derricking cylinder on the revolving platform are adjusted such as to align the corresponding hinge holes of the derricking cylinder and the boom, then the upper pin shaft is inserted into the corresponding hinge holes, so as to hinge and connect the revolving platform with the boom, thereby achieving the connection between the boom and the revolving platform. In disassembling and assembling of a large tonnage wheel crane, by a crane transition assisting device according to the present invention, the disconnection or connection between the boom and the revolving platform may be achieved without an assisting hoisting mechanism. Thus, the disassembling and assembling of the large tonnage wheel crane may be conveniently achieved.

In a further technical solution, the boom bracket is mounted on the bearing frame with the transversely sliding rail extending in the transverse direction of the horizontal plane. When the boom is supported on the bearing frames, according to this technical solution, the boom may be moved in the transverse direction relative to the bearing frame, thus the position of the boom in the transverse direction may be adjusted through the transversely sliding rail. Thus, when the boom is disconnected from or connected with the revolving platform, it is possible to reduce the position adjusting time, and to facilitate pulling out or inserting the main pin shaft and the upper pin shaft. Since the boom has a relatively large weight, in order to facilitate the position adjusting of the boom in the transverse direction, in a preferred technical solution, the transversely sliding hydraulic cylinder is further provided, two ends of which are connected with the bearing frame and the boom bracket respectively, so as to drive the boom bracket to move in the transverse direction relative to the bearing frame by the telescoping of the transversely sliding hydraulic cylinder, thereby achieving the position adjustment of the boom in the transverse direction.

In a further technical solution, the supporting leg further includes the swinging arm extending in the horizontal plane. The outer end of the swinging arm is connected with the upper end part of the hydraulic cylinder, and the inner end thereof is hinged and connected with the bearing frame by the vertical hinge shaft extending in the vertical direction. Thus, the crane transition assisting device in the technical solution has two states which refer to the extending state in which the swinging arm is extendable in the transverse direction when disconnecting and connecting the boom with the revolving platform and a retracting state in which the boom is transferred or transported with a transport trailer. In the extending state, there is a greater width between the hydraulic cylinders in the transverse direction, which can allow the transport trailer and the chassis of the crane to easily move in or out from the underside of the bearing frame, and thus facilitate the disassembling and assembling of the large tonnage wheel crane. In the retracting state, the swinging arm is swayed inwardly and extends in the longitudinal direction, thus there is a smaller distance between the hydraulic cylinders, which reduces the width of the crane transition assisting device in the retracting state, and thus facilitate the transportation and the transition.

In a further technical solution, the upper end part of the hydraulic cylinder and the out end of the swinging arm are hinged with each other by a horizontal hinge shaft. Therefore, the hydraulic cylinder may rotate about the horizontal hinge shaft, so as to can provide a sufficient supporting force for the bearing frame in the extending state, as well as to can make the hydraulic cylinder firstly rotate about the vertical hinge shaft and then rotate about the horizontal hinge shaft by the combination of the horizontal hinge shaft and the vertical hinge shaft in the retracting state, so that the lengthwise direction of the hydraulic cylinder is finally identical to the extending direction of the boom. Thus, in transportation, the crane transition assisting device can have smaller outline dimensions both in the vertical direction and in the transverse direction, thereby improving the trafficability thereof in the retracting state.

In order to improve the bearing ability of the hydraulic cylinder and to increase the stability of the hydraulic cylinder in bearing, in a further technical solution, the upper end part of the hydraulic cylinder is also provided with the supporting platform extending horizontally. When the hydraulic cylinder is supported on the ground, the top surface of the supporting platform abuts against the bottom surface of the swinging arm. Therefore, the supporting area for supporting the weight of the boom may be increased, so as to reduce the stress generated in the horizontal hinge shaft and the upper end part of the hydraulic cylinder due to an external force. To prevent the hydraulic cylinder from deflecting when supporting the boom, in a preferred technical solution, the protruding block extending in the telescoping direction of the hydraulic cylinder is further provided on the top surface of each supporting platform, and the locating hole is further provided in the bottom surface of each swinging arm. The protruding block is engaged with the corresponding locating hole to form a locating mechanism when the top surface of the supporting platform abuts against the bottom surface of the swinging arm. Thus, in the extending state, the engagement between the protruding block and the locating hole can maintain the upper end part of the hydraulic cylinder and the swinging arm to be fixed, thereby improving the strength and the stability of the crane transition assistance device.

In a further preferred technical solution, the horizontal hinge shaft is hinged in the first horizontal hinge hole, which is an elongate hole, of the upper end part of the hydraulic cylinder; or is hinged in the second horizontal hinge hole, which is an elongate hole, of the outer end of the swinging arm. The horizontal hinge shaft may slide in the first elongated horizontal hinge hole or in the second horizontal hinge hole. When the hydraulic cylinder is supported on the ground, the horizontal hinge shaft may slide downwardly relative to the first horizontal hinge hole so as to be adjacent to the lower end of the first horizontal hinge hole; or may slide upwardly relative to the second horizontal hinge hole so as to be adjacent to the upper end of the second horizontal hinge hole. Thus, the hydraulic cylinder is upwardly moved for a suitable distance relative to the swinging arm, so that the protruding block is engaged with the locating hole to maintain the hydraulic cylinder is fixed relative to the swinging arm. When supporting nothing or being suspended, the hydraulic cylinder may move downwardly for a suitable distance relative to the swinging arm under gravity so as to separate the protrude block from the locating hole, thereby facilitate the hydraulic cylinder rotating about the horizontal hinge shaft.

In a further technical solution, the crane transition assisting device further includes the leg withdrawing hydraulic cylinder which drives the hydraulic cylinder to rotate about the horizontal hinge shaft, for facilitating the operation of the rotating movement of the hydraulic cylinder. To cooperate with the locating mechanism formed by the protruding block and the locating hole, in a preferred technical solution, one end of the leg withdrawing hydraulic cylinder is hinged in an elongated leg withdrawing hinge hole of the upper end part of the hydraulic cylinder. Thus, a hinge shaft of the outer end of the leg withdrawing hydraulic cylinder may slide relative to the hydraulic cylinder when the hydraulic cylinder move upwardly or downwardly relative to the swinging arm, so that the leg withdrawing hydraulic cylinder can also operate with the above locating mechanism. Therefore, the locating of the hydraulic cylinder and the swinging arm may be achieved without the need of adjusting the length of the leg withdrawing hydraulic cylinder to adapt to the moving upwardly or downwardly of the hydraulic cylinder.

When the boom is to be unloaded from the transport trailer including the above crane transition assisting device according to the present invention, the hydraulic cylinder may extend out downwardly from the outside of the periphery of the chassis of the transport trailer and may supported on the ground to separate the bearing frame from the chassis of the transport trailer, which facilitate unloading the boom and the crane transition assisting device from the transport trailer. When the boom and the crane transition assisting device are to be loaded, the hydraulic cylinder may be extended out firstly such that the bearing frame has a height above the top surface of the chassis of the transport trailer, and then the transport trailer is driven beneath the bearing frame, and the hydraulic cylinder is retracted to facilitate the loading of the boom and the crane transition assisting device. In the case that the crane transition assisting device includes the swinging arm, in transportation, the crane transition assisting device may be in the retracting state to reduce the outline dimension of the crane transition assisting device, thereby improving the trafficability of the transport trailer.

Based on the crane transition assisting device provided above, the method for assembling and disassembling a crane according to the present invention may simplify the procedure of assembling and disassembling the crane, and reduce the cost of assembling and disassembling the large tonnage wheel crane.

### BRIEF DESCRIPTION OF THE DRAWINGS

FIG. 1 is a perspective structural view of a crane transition assisting device in an extending state according to a first embodiment of the present invention;

FIG. 2 is an enlarged view of I-I part in FIG. 1;

FIG. 3 is a schematic view showing the state of the crane transition assisting device according to the first embodiment located on a transport trailer, with the crane transition assisting device being in a retracting state;

FIG. 4 is a schematic view of a crane transition assisting device located on a transport trailer and supporting a boom in the extending state;

FIG. 5 is a schematic view of the crane transition assisting device according to the first embodiment when the boom is assembled;

FIG. 6 is an exploded structural view of a supporting leg in the crane transition assisting device according to the first embodiment of the present invention;

FIG. 7 is an assembled structural view of the supporting leg in the crane transition assisting device according to the first embodiment of the present invention, showing the state of the supporting leg when the hydraulic cylinder is supported on the ground;

FIG. 8 is a view showing the state of the supporting leg when the hydraulic cylinder is not supported on the ground or is suspended;

FIG. 9 is a view showing the state of the supporting leg after the hydraulic cylinder is rotated about the horizontal hinge shaft;

FIG. 10 is an enlarged view of II-II part in FIG. 1; and

FIG. 11 is a view showing the connecting relationship between a bearing frame and a boom bracket in the crane transition assisting device according to the first embodiment.

### DETAILED DESCRIPTION OF THE INVENTION

The present invention will be described in detail hereinafter in conjunction with the drawings. The description in this section is only illustrative and explanatory, and should not be considered limit to the protection scope of the present invention.

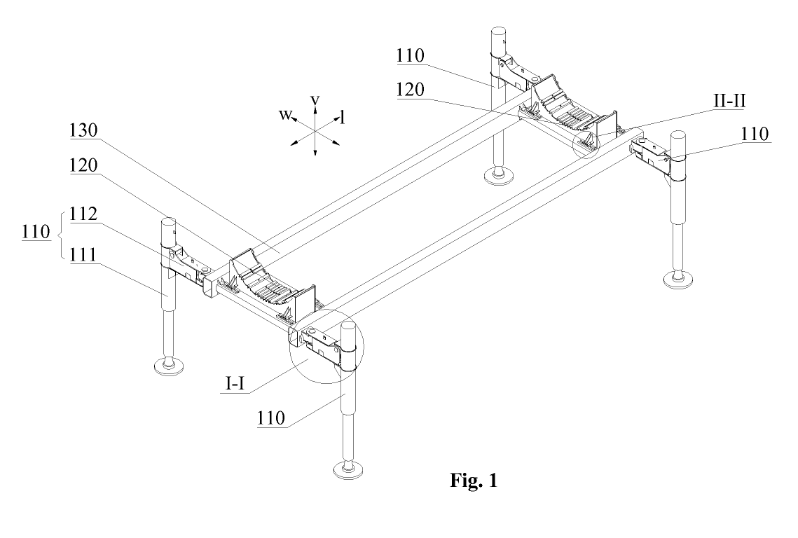

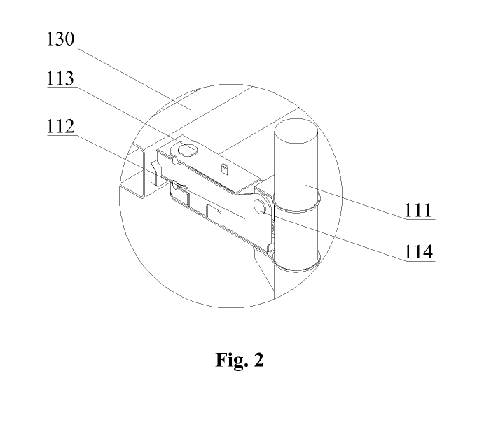

Referring to FIGS. 1 and 2, FIG. 1 is a perspective structural view of a crane transition assisting device in an extending state according to a first embodiment of the present invention, and FIG. 2 is an enlarged view of I-I part in FIG. 1. In order to facilitate the description, directional references are shown in drawings, with v indicating a vertical direction, l indicating a longitudinal direction in a horizontal plane and W indicating a transverse direction in the horizontal plane, wherein the horizontal plane is defined by the longitudinal direction l and the transverse direction W.

The crane transition assisting device according to the first embodiment includes a bearing frame 130 and supporting legs 110 for supporting the bearing frame 130. Each of the supporting leg 110 includes a hydraulic cylinder 111 and a swinging arm 112. In the embodiment, there are four supporting legs 110. For those skilled in the prior art, it is understood that at least three supporting legs may be provided and arranged in a conventional manner. More supporting legs 110 may be provided for obtaining an adequate supporting capacity.

The bearing frame 130 is of a rectangular shape, which forms a bearing surface extending in the horizontal plane. The bearing surface has two boom brackets 120 which are arranged along the longitudinal direction l in the horizontal plane and located on two sides of the bearing frame 130 respectively so as to directly contact with and support the boom. In the embodiment, the boom bracket 120 is formed with a notch being open upwardly. This notch is adapted to the side surface of the boom so as to prevent the boom from rolling in the transverse direction w.

The swinging arm 112 extends in a predetermined direction in the horizontal plane. In FIG. 1, the crane transition assisting device is in an extending state where the swinging arm 112 extends in the transverse direction w in the horizontal plane. An inner end of the swinging arm 112 is hinged with the bearing frame 130 through a vertical hinge shaft 113 extending along the vertical direction v. Four swinging arms 112 are positioned at four corners of the bearing frame 130, respectively. Four hydraulic cylinders 111 correspond to four swinging arms 112 respectively, and a cylinder body as an upper end part of each hydraulic cylinder 111 is hinged with an outer end of the swinging arm 112 by a horizontal hinge shaft 114. The horizontal hinge shaft 114 may extend in a direction parallel to the horizontal plane. In FIG. 1, the horizontal hinge shaft 114 extends in the direction l in the horizontal plane. Thus, the hydraulic cylinder 111 has two degrees of rotational freedom relative to the bearing frame 130. Specifically, on the one hand, the hydraulic cylinder 111 may rotate about the vertical hinge shaft 113 when the swinging arm 112 is rotating about the vertical hinge shaft 113; on the other hand, the hydraulic cylinder 111 may rotate about the horizontal hinge shaft 114. With the combination of the two degrees of rotational freedom, the crane transition assisting device is finally transformed into a retracting state where the length direction of the hydraulic cylinder 111 is parallel to the longitudinal direction l and the crane transition assisting device has a smaller outline dimension.

The working principle of the crane transition assisting device according to the first embodiment will be described below. Meanwhile, a method for assembling and disassembling a crane with the crane transition assisting device according to the invention will also be described.

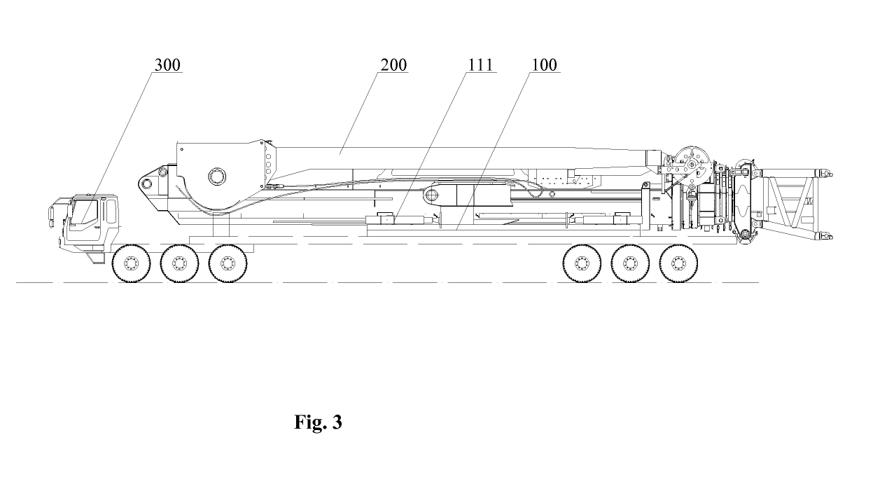

Referring to FIG. 3, a schematic view showing the state of the crane transition assisting device according to the first embodiment located on a transport trailer is shown, with the crane transition assisting device being in a retracting state. When the crane transition assisting device 100 supporting a boom is fixed with the chassis of the transport trailer 300, the crane transition assisting device 100 is in the retracting state where the length direction of the hydraulic cylinder 111 is parallel to the longitudinal direction l and the crane transition assisting device 100 has a smaller outline dimension. In this state, the transport trailer 300 carrying the crane assisting device 100 and the boom 200 has a smaller outline dimension as a whole. Thus, in the case of carrying the crane transition assisting device 100 and the boom 200, the transport trailer 300 still has a good trafficability.

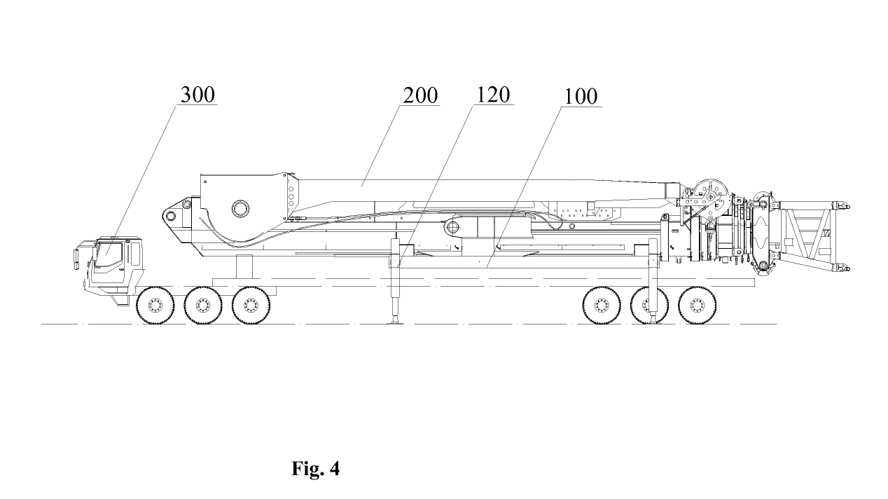

Referring to FIG. 4, a schematic view of a crane transition assisting device located on a transport trailer and supporting a boom in the extending state is shown. A piston, that is a lower end part, of the hydraulic cylinder 111 projects downwardly from the outside of the periphery of the chassis of the transport trailer 300, and is supported on the ground by means of a hydraulic force, such that the bearing frame 130 is gradually separated from the upper surface of the chassis of the transport trailer 300. At this moment, the transport trailer 300 may drive away from the underside of the bearing frame 130.

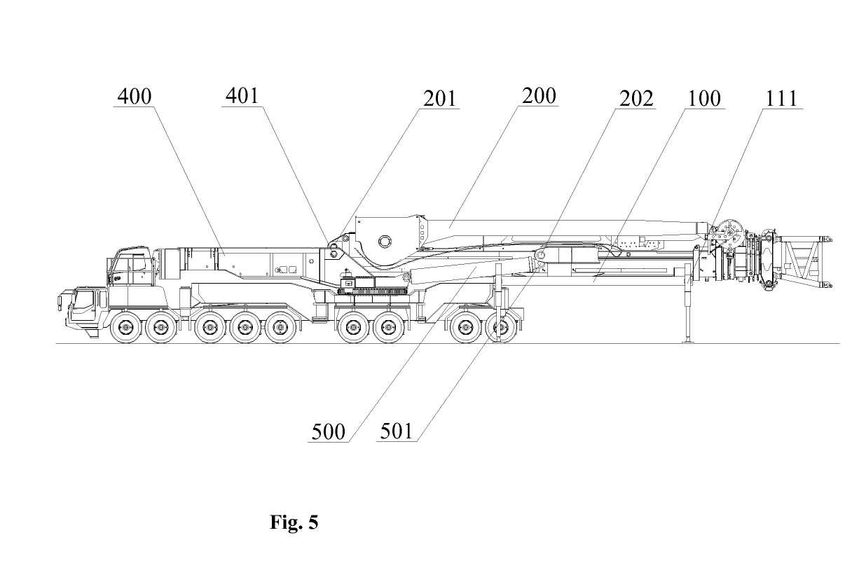

Referring to FIG. 5, a schematic view of the crane transition assisting device according to the first embodiment when the boom is assembled is shown. After the transport trailer 300 have driven away from the underside of the bearing frame 300, the large tonnage wheel crane may be driven such that a part of its chassis is moved beneath the bearing frame 130, until a revolving platform 400 is positioned below the bearing frame 130. It is possible to align a hinge hole 401 of the revolving platform 400 with a hinge hole 201 of the boom 200 in the vertical direction v by adjusting the chassis of the crane or adjusting the crane transition assisting device in the transverse direction w and in the longitudinal direction l. Then, the bearing frame 130 is lowered by adjusting the extension amount of the piston of the hydraulic cylinder 111, such that the hinge hole 201 of the boom 200 are located at the same height with the hinge hole 401 of the revolving platform 400. Thus, the hinge hole 201 can be leveled with the hinge hole 401, and a main pin shaft can be inserted into the hinge holes 201 and 401, so that the boom 200 is hinged with the revolving platform 400. Meanwhile, it is also possible to adjust the relative position of a derricking cylinder 500 relative to the boom 200 so as to align the hinge hole 501 of the derricking cylinder 500 with the hinge hole 202 of the boom 200, and to insert an upper pin shaft into the hinge holes 501 and 202 so as to hinge the derricking cylinder 500 with the boom 200. Thus, the connection between the boom 200 and the revolving 400 is achieved.

The boom 200 may be detached from the revolving platform 400 through a reversed process, which is described in detail as follows:

driving a large tonnage wheel crane to a suitable position and adjusting the position of the boom 200 by the derricking cylinder 500; placing the crane transition assisting device 100 under the boom 200 and supporting the boom 200 on the boom bracket 120; adjusting the position of the derricking cylinder 500 and the height of the bearing frame 130 to make the main pin shaft and the upper pin shaft easier to be pulled out, and then pulling out the upper pin shafts hinging the derricking cylinder 500 with the boom 200, and pulling out the main pin shaft hinging the boom 200 with the revolving platform 400, thus separating the boom and the revolving platform 400.

After the boom 200 is supported on the crane transition assisting device, the large tonnage wheel crane is moved away, and the transport trailer 300 is subsequently driven to the underside of the bearing frame 130. Then, the bearing frame 130 is supported on the chassis of the transport trailer 300 by retracting the hydraulic cylinder 111. The crane transition assisting device 100 is then transformed from the extending state into the retracting state. The boom 200 and the crane transition assisting device 100 are transported to a predetermined location or position by the transport trailer 300.

According to above description, it is certain that, when the crane transition assisting device 100 according to the embodiment is used to disassemble and assemble the large tonnage wheel crane, the transition operating process can be simplified to facilitate the detaching and installing of the boom 200, and the transition operating cost of the large tonnage crane may be lowered since it is unnecessary to hoist the boom 200 by an assisting hosting mechanism.

It is understood that the crane transition assisting device 100 according to the first embodiment has two states, that is, an extending state and a retracting state. When the boom 200 and the revolving platform 400 are disconnected or connected, the crane transition assisting device 100 is in the extending state where the swinging arm 112 may be extended in the transverse direction w. At this moment, there is a larger width between the hydraulic cylinders 111 in the transverse direction, thus it is easy for the transport trailer 300 and the chassis of the crane to move to or out from the underside of the bearing frame 130, which facilitates the disassembling and assembling of the large tonnage wheel crane. In the retracting state, the swinging arm 112 sways inwardly and extends in the longitudinal direction l, such that there is a smaller distance between the hydraulic cylinders 111 in the transverse direction w and the width of the crane transition assisting device 100 in the retracting state may be reduced, which facilitates the transportation and transition.

When the hydraulic cylinder 111 is hinged with the swinging arm 112 by a horizontal hinge shaft 114, the hydraulic cylinder 111 may rotate about the horizontal hinge shaft 114. In the extending state, the hydraulic cylinder 111 can provide an adequate supporting force for the bearing frame 130. In the retracting state, with the combination of the horizontal hinge shaft 114 and the vertical hinge shaft 113, the hydraulic cylinder 111 may rotate about the horizontal hinge shaft 114 after firstly rotating about the vertical hinge shaft 113, and finally the extending direction of the hydraulic cylinder 111 is the same as the extending direction of the boom 200. Thus, in the retracting state, it is possible for the crane transition assisting device 100 to have smaller outline dimensions both in the vertical direction v and in the transverse direction w, thereby improving the trafficability of the crane transition assisting device 100 in the retracting state.

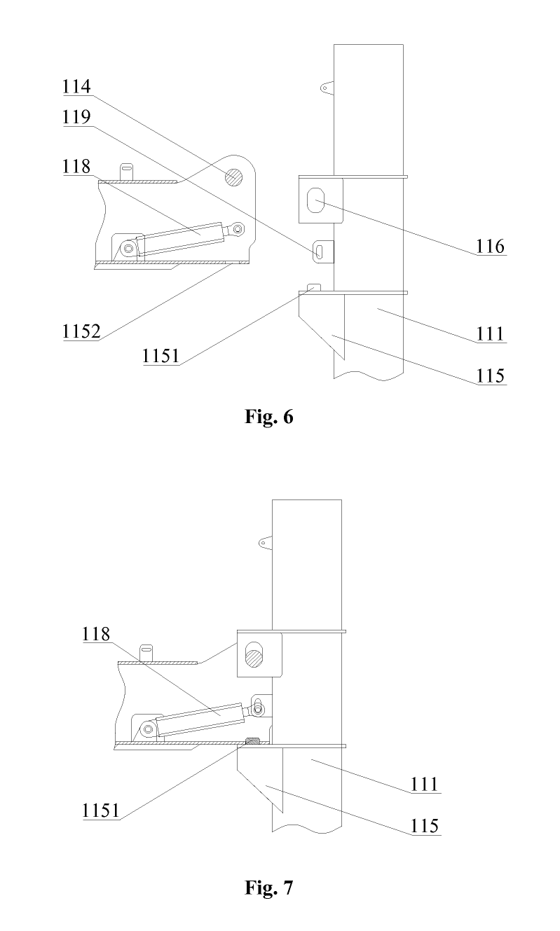

Referring to FIGS. 6 and 7, FIG. 6 is an exploded structural view of a supporting leg in the crane transition assisting device according to the first embodiment of the present invention; and FIG. 7 is an assembled structural view of the supporting leg in the crane transition assisting device according to the first embodiment of the present invention, showing the state of the supporting leg when the hydraulic cylinder is supported on the ground.

An upper end part of the hydraulic cylinder 111 is also provided with a supporting platform 115 stretched out horizontally. A top surface is formed at the upper portion of the supporting platform 115. When the crane transition assisting device 100 is in the extending state and the lower end of the hydraulic cylinder 111 is supported on the ground, the top surface of the supporting platform 115 abuts against the bottom surface of the swinging arm 112. Such a structure has advantages that the supporting area for supporting the weight of the boom 200 may be increased and the stress generated in the horizontal hinge shaft 114 and the upper end part of the hydraulic cylinder 111 due to an external force may be reduced. To prevent the hydraulic cylinder 111 from deflecting and maintain the hydraulic cylinder 111 to be fixed relative to the swinging arm 112, the top surface of the supporting platform 115 is further provided with a protruding block 1151 extending upwardly in the telescoping direction of the hydraulic cylinder 111, that is, in the vertical direction v, and the bottom surface of the swinging arm 112 is further provided with a locating hole 1152. When the top surface of the supporting platform 115 abuts against the bottom surface of the swinging arm 112, the protruding block 1151 is engaged with the locating hole 1152 to form a locating mechanism, thus achieving the locating of the hydraulic cylinder 111. Thus, when a lateral force is applied to the hydraulic cylinder 111, the hydraulic cylinder 111 may be maintained to be vertical by means of the locating mechanism formed of the protruding block 1151 and the locating hole 1152, so as to improve the strength and the stability of the crane transition assisting device 100.

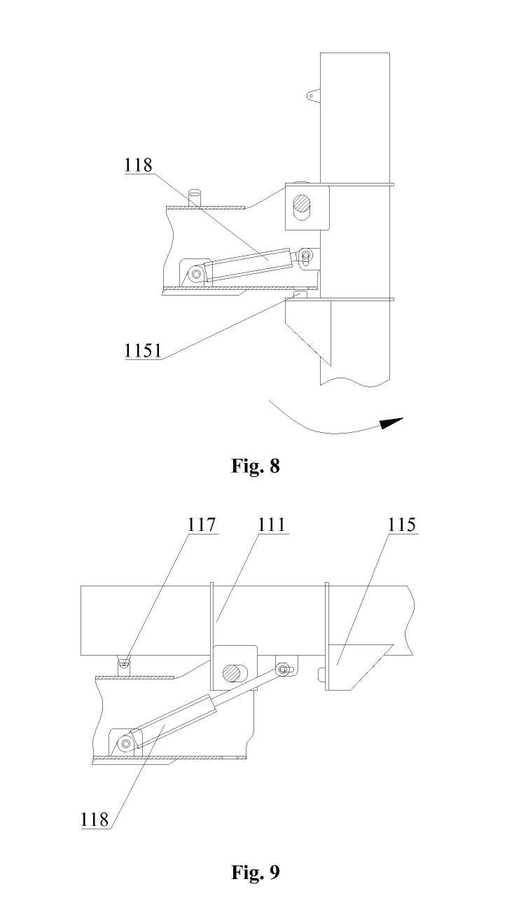

Referring to FIGS. 8 and 9, FIG. 8 is a view showing the state of the supporting leg when the hydraulic cylinder is not supported on the ground or is suspended; and FIG. 9 is a view showing the state of the supporting leg after the hydraulic cylinder is rotated about the horizontal hinge shaft.

In the case that there is the protruding block 1151, to facilitate the rotating of the hydraulic cylinder 111 about the horizontal hinge shaft 114, in the embodiment, an elongated first horizontal hinge hole 116 is further provided at the outer side of the body of the hydraulic cylinder 111. The first horizontal hinge hole 116 may be a usual elongated hole with its upper part, lower part and middle part having a same width, or may be a waist-shaped hole with its upper part and lower part being wider and its middle part being narrower. The first horizontal hinge hole 116 has a predetermined length in the telescopic direction of the hydraulic cylinder. In the embodiment, the length of the first horizontal hinge hole 116 is substantially the same as the height of the protruding block 1511. Alternatively, the length of the first horizontal hinge hole 116 may be slightly greater than the height of the protruding block 1511. Tow end parts of the horizontal hinge shaft 114 are engaged with a second horizontal hinge hole (not shown) of the outer end of the swinging arm 112, with the first elongated horizontal hinge hole 116 passing through the middle of the horizontal hinge shaft 114. As shown in FIG. 7, when the hydraulic cylinder 111 is supported on the ground, the horizontal hinge shaft 114 lies on the lower end of the first horizontal hinge hole 116. As shown in FIG. 8, when the hydraulic cylinder 111 provides no supporting force or is suspended, the horizontal hinge shaft 114 lies on the upper end of the first horizontal hinge hole 116. Thus, when the hydraulic cylinder 111 provides no supporting force or is suspended, the hydraulic cylinder moves downwardly relative to the swinging arm 112, and the protruding block 1511 is just separated from the locating hole 1152, in this case, the hydraulic cylinder 111 may be very easily turned upwardly, as indicated by an arrow shown in FIG. 8, is rotated about the horizontal hinge shaft 114 so as to make the length direction of the hydraulic cylinder 111 parallel to the horizontal plane, and reaches the position shown in FIG. 9. It is understood that, in order to facilitate the upwardly turning of the hydraulic cylinder 111, the second horizontal hinge hole of the outer end of the swinging arm 112 may also be designed as an elongated hole and has a predetermined length in the vertical direction, by which the object described above can also be achieved. In this case, when the hydraulic cylinder 111 is supported on the ground, the horizontal hinge shaft 114 is adjacent to the upper end of the second horizontal hinge hole, and when the hydraulic cylinder 111 is not supported on the ground and is suspended, the horizontal hinge shaft 114 is adjacent to the lower end of the second horizontal hinge hole. It will be understood for those skilled in the art that, in the case that there is a locating mechanism formed by the protruding block 1511 and the locating hole 1152 and the hydraulic cylinder 111 has a relatively light weight, the horizontal hinge shaft 114 may be provided in a detachable manner. In this way, when the hydraulic cylinder 111 is required to be turned upwardly, the horizontal hinge shaft 114 may be pulled out at first to eliminate the locating by separating the protruding block 1151 from the locating hole 1152; next, the horizontal hinge shaft 114 is mounted again and the hydraulic cylinder 111 is then turned, or the hydraulic cylinder is directly placed on the predetermined position. The protruding block 1151 may be alternatively provided as a telescopic block, which is extended upwardly if needed and is retracted if not needed.

In order to maintain the lengthwise direction of the hydraulic cylinder 111 to be parallel to the horizontal plane, a locking mechanism 117 may be further provided, which may includes locking holes disposed on the outer sides of the swinging arm 112 and the hydraulic cylinder 111 respectively. After the hydraulic cylinder is turned upwardly, the two locking holes mentioned above are aligned with each other and the hydraulic cylinder 111 is locked at the upwardly turned position by a suitable locking pin. If the hydraulic cylinder 111 is required to be turned downwardly, the locking pin is removed, such that the hydraulic cylinder 111 may be rotated about the horizontal hinge shaft 114 in a reverse direction.

If the hydraulic cylinder 111 has a relatively large weight, it is a hard work to turn the hydraulic cylinder 111 manually. In order to reduce the work intensity of the operator and improve the operating automation level of the crane transition assisting device 100, as shown in FIGS. 6, 7, 8 and 9, the supporting leg 111 in the first embodiment may further include a leg withdrawing hydraulic cylinder 118 which has an inner end hinged with the swinging arm 112 and an outer end hinged with the a leg withdrawing hinge hole 119 of the upper end part of the hydraulic cylinder 111. When the leg withdrawing hydraulic cylinder 118 is extended, the hydraulic cylinder 111 may be driven to turn outwardly. When the leg withdrawing hydraulic cylinder 118 is retracted, the hydraulic cylinder 111 may be rotated in a reverse direction. To adapt to position variations caused by the engagement and separation between the protruding block 1151 and the locating hole 1152, the leg withdrawing hinge hole 119 may be provided as an elongated hole having a predetermined length in the telescoping direction of the hydraulic cylinder 111. Of course, the leg withdrawing hinge hole 119 may be a usual hole, and the position variations caused by the engagement and separation between the protruding block 1151 and the locating hole 1152 may also be adapted by adjusting the length of the leg withdrawing hydraulic cylinder 118.

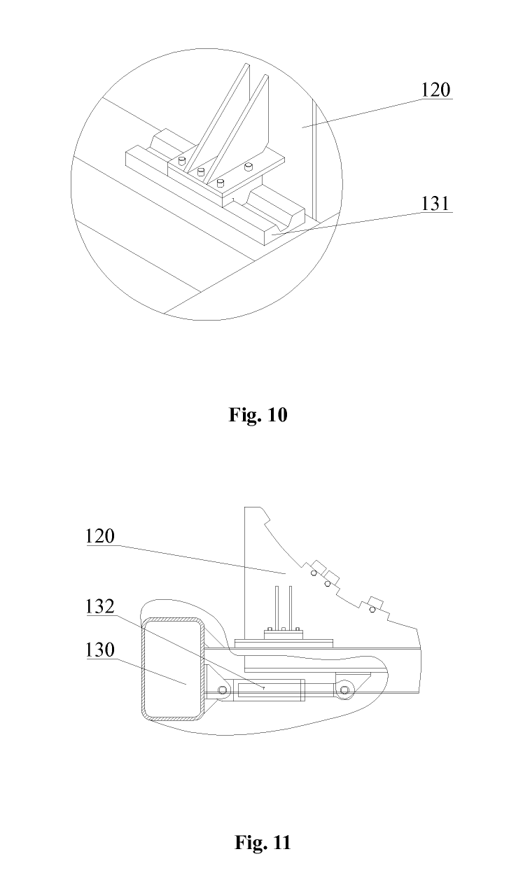

Referring to FIG. 10, it is an enlarged view of II-II part in FIG. 1. In disconnecting and connecting between the boom 200 and the revolving platform 400, in order to facilitate the adjusting of the boom bracket 120 in the transverse direction w, the boom bracket 120 is slidably mounted on a transversely sliding rail 131 of the bearing frame 130. The transversely sliding rail 131 extends in the transverse direction w of the horizontal plane. Thus, when the boom 200 is mounted on or detached from the revolving platform 400, the boom bracket 120 may be moved in the transverse direction w relative to the bearing frame 130, which avoids the adjustment of the chassis of the crane or the overall crane transition assisting device repeatedly and improves the operating efficiency of disassembling or assembling the boom 200. In the embodiment, the transversely sliding rail 131 is a rail with a long channel, and the boom bracket 120 is provided with a protrusion engaged with this long channel. The slidable connection between the boom bracket 120 and the bearing frame 130 may be achieved in another specific manner disclosed in the prior art. For example, in order to decrease the friction during sliding, a rolling wheel and a rolling rail matched with each other may be provided.

Referring to FIG. 11, it is a structural view showing the connecting relationship between the bearing frame and the boom bracket in the crane transition assisting device according to the first embodiment. Since the boom 200 has a relatively large weight, in order to facilitate the sliding of the boom bracket 120 for supporting the boom 200 in the transverse direction w to adjust the position of the boom 200 in transverse direction w, the crane transition assisting device in the first embodiment may be further provided with a transversely sliding hydraulic cylinder 132 having two ends hinged with the bearing frame 130 and the boom bracket 120 respectively. The telescoping direction of the transversely sliding hydraulic cylinder 132 is perpendicular to the longitudinal direction v. Alternatively, two ends of the transversely sliding hydraulic cylinder 132 may be fixed with the bearing frame 130 and the boom bracket 120, respectively. In this case, it is necessary that the telescoping direction of the transversely sliding hydraulic cylinder 132 is parallel to the transverse direction w.

Based on the crane transition assisting device provided above, the transport trailer is provide and includes the above crane transition assisting device 100. The bearing frame 130 is supported on the chassis of the transport trailer 300, and the lower end part of the hydraulic cylinder may protrude downwardly from the outside of the periphery of the chassis of the transport trailer 300 to facilitate being supported on the ground.

The above-mentioned description is just the preferred embodiments of the present invention. It should be noted that, for the skilled in the art, some improvements and modifications may be made without departing from the principles of the present invention. These improvements and modifications should be deemed to fall into the scope of protection of the present invention.

1. A crane transition assisting device, comprising a bearing frame and at least three supporting legs each mounted on the bearing frame, wherein each of the supporting legs comprises a hydraulic cylinder which is telescopic in a vertical direction; and at least two boom brackets arranged in a longitudinal direction of a horizontal plane and configured to support a boom of a crane are provided on the bearing frame.

2. The crane transition assisting device according to claim 1, wherein each of the boom brackets is slidably mounted on a transversely sliding rail of the bearing frame, and the transversely sliding rail extends in a transverse direction of the horizontal plane.

3. The crane transition assisting device according to claim 2, further comprising transversely sliding hydraulic cylinders which are telescopic in a direction perpendicular to the longitudinal direction, wherein two ends of each transversely sliding hydraulic cylinder are respectively connected with the corresponding boom bracket and the bearing frame.

4. The crane transition assisting device according to any of claim 1, wherein each of the supporting legs further comprises a swinging arm extending in a direction parallel to the horizontal plane, and an outer end of the swinging arm is connected to an upper end part of the corresponding hydraulic cylinder, and an inner end of the swinging arm is hinged with the bearing frame by a vertical hinge shaft extending in the vertical direction.

5. The crane transition assisting device according to claim 4, wherein the outer end of the swinging arm is hinged with the upper end part of the corresponding hydraulic cylinder by a horizontal hinge shaft extending in a direction parallel to the horizontal plane.

6. The crane transition assisting device according to claim 5, wherein the upper end part of each hydraulic cylinder further comprises a supporting platform extending horizontally, and a top surface of the supporting platform abuts against a bottom surface of the corresponding swinging arm when the corresponding hydraulic cylinder is supported on the ground.

7. The crane transition assisting device according to claim 6, wherein a protruding block extending in the telescoping direction of the hydraulic cylinder is further provided on the top surface of each supporting platform, and a locating hole is further provided in the bottom surface of each swinging arm; the protruding block is engaged with the corresponding locating hole when the top surface of the supporting platform abuts against the bottom surface of the swinging arm.

8. The crane transition assisting device according to claim 7, wherein each of the horizontal hinge shafts is hinged in a first horizontal hinge hole of the upper end part of the corresponding hydraulic cylinder, the first horizontal hinge hole is an elongated hole having a predetermined length in the telescoping direction of the hydraulic cylinder; and the horizontal hinge shaft is adjacent to a lower end of the first horizontal hinge hole when the hydraulic cylinder is supported on the ground;
alternatively, each of the horizontal hinge shafts is hinged in a second horizontal hinge hole of the outer end of the corresponding swinging arm, the second horizontal hinge hole is an elongated hole having a predetermined length in the vertical direction; and the horizontal hinge shaft is adjacent to an upper end of the second horizontal hinge hole when the hydraulic cylinder is supported on the ground.

9. The crane transition assisting device according to any of claim 5, wherein each of the supporting legs further comprises a leg withdrawing hydraulic cylinder, an inner end of the leg withdrawing hydraulic cylinder is hinged with the corresponding swinging arm, and an outer end of the leg withdrawing hydraulic cylinder is hinged with a leg withdrawing hinge hole of the upper end part of the hydraulic cylinder.

10. The crane transition assisting device according to claim 9, wherein each of the leg withdrawing hinge holes is an elongated hole having a predetermined length in the telescoping direction of the corresponding hydraulic cylinder.

11. A transport trailer comprising the crane transition assisting device according to any of claim 1, wherein the bearing frame is supported on a chassis of the transport trailer, and the lower end part of each hydraulic cylinder protrudes downwardly from the outside of the periphery of the chassis of the transport trailer.

12. A method for assembling a crane with the crane transition assisting device according to any of claim 1, comprising the steps of:
extending the hydraulic cylinder to move the bearing frame and the boom upwardly;
placing the revolving platform of the crane under the bearing frame, adjusting the height of the bearing frame, aligning corresponding hinge holes of the boom and the revolving platform, inserting a main pin shaft into the corresponding hinge holes so as to hinge the boom with the revolving platform; and
adjusting a derricking cylinder on the revolving platform so as to align corresponding hinge holes of the derricking cylinder and the boom, and then inserting an upper pin shaft into the corresponding hinge holes so as to hinge and connect an upper end of the derricking cylinder with the boom.

13. (canceled)

14. The transport trailer according to claim 11, wherein each of the boom brackets is slidably mounted on a transversely sliding rail of the bearing frame and the transversely sliding rail extends in a transverse direction of the horizontal plane.

15. The transport trailer according to claim 14, further comprising transversely sliding hydraulic cylinders which are telescopic in a direction perpendicular to the longitudinal direction, wherein two ends of each transversely sliding hydraulic cylinder are respectively connected with the corresponding boom bracket and the bearing frame.

16. The transport trailer according to claim 11, wherein each of the supporting legs further comprises a swinging arm extending in a direction parallel to the horizontal plane, and an outer end of the swinging arm is connected to an upper end part of the corresponding hydraulic cylinder, and an inner end of the swinging arm is hinged with the bearing frame by a vertical hinge shaft extending in the vertical direction.

17. The transport trailer according to claim 16, wherein the outer end of the swinging arm is hinged with the upper end part of the corresponding hydraulic cylinder by a horizontal hinge shaft extending in a direction parallel to the horizontal plane.

18. The transport trailer according to claim 17, wherein the upper end part of each hydraulic cylinder further comprises a supporting platform extending horizontally, and a top surface of the supporting platform abuts against a bottom surface of the corresponding swinging arm when the corresponding hydraulic cylinder is supported on the ground.

19. The transport trailer according to claim 18, wherein a protruding block extending in the telescoping direction of the hydraulic cylinder is further provided on the top surface of each supporting platform, and a locating hole is further provided in the bottom surface of each swinging arm; the protruding block is engaged with the corresponding locating hole when the top surface of the supporting platform abuts against the bottom surface of the swinging arm.

20. The transport trailer according to claim 19, wherein each of the horizontal hinge shafts is hinged in a first horizontal hinge hole of the upper end part of the corresponding hydraulic cylinder, the first horizontal hinge hole is an elongated hole having a predetermined length in the telescoping direction of the hydraulic cylinder; and the horizontal hinge shaft is adjacent to a lower end of the first horizontal hinge hole when the hydraulic cylinder is supported on the ground;
alternatively, each of the horizontal hinge shafts is hinged in a second horizontal hinge hole of the outer end of the corresponding swinging arm, the second horizontal hinge hole is an elongated hole having a predetermined length in the vertical direction; and the horizontal hinge shaft is adjacent to an upper end of the second horizontal hinge hole when the hydraulic cylinder is supported on the ground.

21. The transport trailer according to claim 17, wherein each of the supporting legs further comprises a leg withdrawing hydraulic cylinder, an inner end of the leg withdrawing hydraulic cylinder is hinged with the corresponding swinging arm, and an outer end of the leg withdrawing hydraulic cylinder is hinged with a leg withdrawing hinge hole of the upper end part of the hydraulic cylinder.
